(19) United States
(12) Patent Application Publication
(10) Pub. No.: US 2025/0143294 A1
(43) Pub. Date: May 8, 2025

(54) N-CONTAINING/HUMIC FERTILIZER AND PREPARING METHODS THEREOF

(71) Applicant: Huma, Inc., Gilbert, AZ (US)

(72) Inventor: Richard T. Lamar, Gilbert, AZ (US)

(21) Appl. No.: 18/937,498

(22) Filed: Nov. 5, 2024

Related U.S. Application Data
(60) Provisional application No. 63/547,676, filed on Nov. 7, 2023.

(51) Int. Cl. A01N 33/00; A01N 61/00

(52) U.S. Cl. CPC A01N 33/00; A01N 61/00

(57) ABSTRACT

Methods of making N-containing component/humic substance fertilizers and resulting fertilizers are described. In one example, a method of making N-containing component/humic substance fertilizers includes the steps of adding 20-35 weight percent of humic substance to molten N-containing component, for example urea, and mixing under high shear. In another example, a method of making includes the steps of mixing 20 to 35 weight percent humic substance with a N-containing component and heating to form a molten mixture. Methods of making N-containing component/humic substance fertilizers.

### PRIORITY

This application claims the benefit of U.S. application No. 63/547,676 filed, Nov. 7, 2023, incorporated by reference herein in its entirety.

### FIELD OF THE INVENTION

The present invention relates in general to environmentally efficient Nitrogen-containing fertilizer. More specifically, the present invention relates to methods of making Nitrogen-containing component/humic substance fertilizer that is designed to replace other Nitrogen-containing fertilizers for agricultural use.

### BACKGROUND OF THE INVENTION

Nitrogen (N) has become the major factor in global biogeochemical pollution. Application of nitrogenous fertilizers to agricultural fields is the greatest anthropogenic source of nitrogenous gases, including ammonia (NH₃), nitric oxide (NO) and nitrous oxide (N₂O), release to the atmosphere. Enhanced soil N₂O, NO, and NH₃ emissions from the increasing use of N-based fertilizers contribute to global warming, tropospheric ozone production, stratospheric ozone destruction, NH₄⁺ aerosol formation, and N₂O release. As a greenhouse gas, N₂O is about 288 times stronger than CO₂.

Also, N transported and deposited in remote and sensitive ecosystems changes soil and water chemistry and biodiversity. In addition, excess N in the form of for example, NO₃ from agricultural runoff and leaching and the resulting inputs to aquatic ecosystems cause widespread eutrophication, hypoxia, and groundwater pollution. While degraded water and air pose direct health risk to humans, rising temperature and ozone levels can cause severe damages to major commodity crop production affecting food security.

Urea is the most widely used N fertilizer in the world, accounting for some 62% of global demand for N. Total consumption of urea by agriculture in North America in 2020 was 8.9M tonnes. Use of urea can result in losses of urea-N via NH₃ volatilization, leaching of NO₂⁻ and NO₃⁻ and by volatilization of NO, and N₂O upon further denitrification of NO₃⁻.

Other N-containing fertilizers used include ammonium forms such as ammonium nitrate, ammonium sulfate, ammonium phosphate, and diammonium phosphate. Nitrate forms include calcium nitrate and liquid forms such as anhydrous ammonia and urea ammonium nitrate. Use of these fertilizers can result in losses of reactive nitrogen species such as, N₂O and NO₃ which may negatively impact human and environmental health.

Therefore, there is a need for the development of cost effective, environmentally efficient N-containing fertilizers to both increase N use efficiency, which allows application of less N to achieve identical or better productivity, and prevent loss of N to reduce negative environmental impacts from agricultural urea fertilizer use.

Humic substances (HS) are used as crop plant biostimulants because, under the right conditions, they elicit a metabolic reprogramming in plants that includes up-regulation of important metabolic processes like photosynthesis, glycolysis and the tricarboxylic acid cycle, the antioxidant defense, and nutrient uptake systems, and they induce phenotypic changes primarily in root system architecture to enhance nutrient and water foraging and uptake capacities.

Metabolic reprogramming, which follows a mild stress response (i.e., eustress), primes plants to enable them to cope with biotic and abiotic stresses, which inevitably occur during any growing season, and to maintain or improve productivity.

Up-regulation of the antioxidant defense system is important to counterbalance the overproduction of reactive oxygen species (ROS) that occurs during the stress response (i.e., the oxidative burst). ROS, when overproduced indiscriminately destroy proteins (e.g., enzymes and nutrient transporters), lipids (e.g., cell membranes), and nucleic acids (e.g., DNA and RNA) leading to reduced metabolic functioning or in extreme cases, death.

HS applied to plants has been shown to up-regulate the production of antioxidant enzymes (e.g., superoxide dismutase, catalase) and non-enzymatic antioxidants (e.g., ascorbic acid, glutathione) that quench ROS, which eliminates or minimizes oxidative damage. HS also up-regulate important proteins like plasma membrane (PM) H⁺-ATPases, the activities of which provides the proton motive force (PMF) which is the driving force for ion and solute transport into and out of cells and therefore plays a crucial role in nutrient N uptake.

In addition, HS also up-regulate the genes responsible for production of transport proteins responsible for NO₃ and urea uptake into root cells. Collectively, up-regulation of PM H⁺-ATPases and nitrate and urea transporters can result in increased N uptake, particularly in stressed plants.

Further, due primarily to their carboxylic and phenolic hydroxyl functional groups, HS can interact and bind NH₄⁺ through cation exchange when these carboxylic and phenolic hydroxyl groups become de-protonated and negatively charged and NH₃ via hydrogen bonding. The ability of humic substances to reduce NH₃ volatilization has been demonstrated previously. For example, mixing humic acids (HA) isolated from peat with soil-applied urea significantly reduced NH₃ loss compared to pure urea and increased concentrations of retained NH₄⁺ and NO₃⁻.

Similarly, combining urea with HA and fulvic acids, isolated from coal, either alone or together, decreased NH₃ volatilization from urea applied to soil by 13 to 25%, compared to pure urea, depending on the treatment. In the same study, the soil concentrations of NH₄⁺ and NO₃⁻ were also higher than in soils amended with pure urea. There are numerous similar examples in the literature.

Additionally, N-containing fertilizers in solid form, for example granule, pellet, prill, pastille or extrudate need to have a hardness sufficient to with stand handling, packaging and shipping.

### SUMMARY OF THE INVENTION

The present invention teaches a more environmentally efficient N-containing fertilizer in terms of providing optimum N uptake in a timely manner while minimizing N loss that can occur via volatilization of NH₃, NO, N₂O and leaching of NO₃⁻ and NO₂⁻ and the negative environmental impacts that can result.

The present application discloses methods of making N-containing component/humic substance fertilizer that is designed to replace pure N-containing fertilizers for agricultural use.

In an embodiment, a method comprises the steps of: heating a solid nitrogen-containing component, adding a particulate humic substance having a mean particle size of less than 35 μm to the molten nitrogen-containing component in the amount of 10 to 35 weight percent based on the total weight of the nitrogen-containing component and the humic substance, mixing the molten nitrogen containing component and the humic substance under high shear to form a substantially uniform molten fertilizer mixture, forming fertilizer granules of the molten fertilizer mixture and actively cooling the fertilizer granules.

In an embodiment, a method comprises the steps of mixing 10 to 35 weight percent nitrogen-containing component with 65 to 90 weight percent of a humic substance having a mean particle size of less than 35 μm to form a mixture, heating the mixture to form a liquid mixture, forming granules from the molten mixture and actively cooling the granules.

In embodiments of methods described in this disclosure, the humic substance comprises 40-100 weight percent fulvic acid; the humic substance comprises 40-100 weight percent humic acid; the granules are in the form of pastilles, pellets, extrudates, prills, powders or granules; the nitrogen containing component is monoammonium phosphate, diammonium phosphate or urea; the humic substance is selected from the group consisting of oxidized subbituminous coal, brown coal, lignite, oxidized lignite, peat, compost or mixtures thereof; and/or the methods further comprise the step of applying at least one coating to the pastilles, pellets, extrudates, prills, powders or granules.

In an embodiment, a fertilizer comprises granules comprising 10 to 35 percent by weight of a humic substance and 65 to 85 percent by weight of a nitrogen-containing component, the granules are made by heating a solid nitrogen-containing component, adding a particulate humic substance having a mean particle size of less than 35 μm to the heated nitrogen-containing component in the amount of 10 to 35 weight percent based on the total weight of the nitrogen-containing component and the humic substance, mixing the heated nitrogen containing component and the humic substance under high shear to form a substantially uniform fertilizer mixture, forming granules from the fertilizer mixture and actively cooling the granules.

In an embodiment, a fertilizer comprises granules comprising from 10 to 35 percent by weight of a humic substance and from 65 to 90 percent by weight of a granulated nitrogen containing component, the granules made by mixing from 65 to 90 weight percent granulated N-containing component with from 15 to 35 weight percent of a humic substance having a mean particle size of less than 35 μm to form a mixture, heating the mixture to form a molten mixture, forming the granules from the molten mixture and actively cooling the granules.

In embodiments of fertilizers of this disclosure the humic substance comprises 40 to 100 percent by weight humic acid, fulvic acid or a combination thereof.

In an embodiment, the N-containing component/humic substance fertilizer disclosed by the present application is produced using a pastillation process in which N-containing component is melted to a molten state, humic substance is mixed into the molten N-containing component under high shear conditions, and the molten mix is subjected to a pastillation process. In one embodiment, the resulting fertilizer is a hard, dust-free, 6-mm pastille that has 36% by weight N and 15% by weight humic acid. In addition to pastillation, other prilling technologies, for example, either fluidized bed or non-fluidized bed, extrusion and granulation technologies that employ molten urea/N-containing components could be used

### BRIEF DESCRIPTION OF THE DRAWINGS

The accompanying drawings, which are incorporated herein and form a part of the specification, illustrate the present invention and, together with the description, further explain the principles of the invention and to enable a person skilled in the pertinent art to make and use the invention.

FIG. 1. Ammonia volatilization from urea/humate ore pastilles prepared with 0.5, 1, 2.5, 5, 10 and 20% pulverized humate ore, compared to pure urea pastilles.

FIG. 2a shows an exemplary system used for electrostatic coating.

FIG. 2b illustrates urea/humate ore fertilizer pastilles coated with an EC/DBS coating system.

FIG. 3 shows a 600-ml jacketed reactor.

FIG. 4 illustrates urea in the jacketed beaker.

FIG. 5 illustrates a light and foaming urea/humate ore mixture.

FIG. 6 illustrates a mixture of granulated urea (75%) and micronized humate ore (25%).

FIG. 7 illustrates a urea/humate mixture in a 600-ml jacketed beaker.

FIG. 8 illustrates a flowable texture of pre-mixed urea/humate ore after melting.

FIGS. 9-10 are lab reports for two batches of 20% mixtures.

FIG. 11 is a lab report for a 25% mixture.

### DETAILED DESCRIPTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

### Definitions

“Mixing under high shear” means a process that uses a high-speed rotor and a stationary stator to create shear force and disperse, blend, or emulsify materials.

“Micronized” means reduction of the particle size of a solid to less than 10 micrometers.

“Humic substance” includes materials that include humic acid, fulvic acid, humins or mixtures thereof.

“Granules” means granules, pellets, pastilles, prills and extrudates.

“Hardness” means the resulting pellets/granules/extrudate/pastilles have a sufficient crushing strength. Useful crushing strengths for prills are 0.8 to 1.2 kg/prill; and 1.5 to 3.5 kg/pellets/granules/extrudates/pastilles as measured by a hand-powered compression tester.

In one embodiment, a method of making a N-containing component/humic substance fertilizer provides the high nitrogen (N) concentration of urea and a low concentration of biuret together with the biostimulant capacities of humic substances in one hard, flowable, dust-free pastille. The inclusion of from 20 to 35 percent by weight humic substances combined with 80 to 65 weight percent molten N-containing component according to the methods described in this application increases the effectiveness and the efficiency of the N-containing component/humic substance fertilizer.

In another embodiment, the N-containing component may be powdered or granulated and premixed with a humic substance present at 20-35 weight percent prior to melting of the combined mixture.

In another embodiment, the methods of the disclosure include a applying a coating to the fertilizer, for example, a coating comprising ethyl cellulose and a plasticizer such as butyl sebacate.

In another embodiment, methods of this disclosure provide a coated or noncoated pastille with a N-containing component concentrations of from 99.5% to 70% by weight and a humic substance concentration of from 0.5% to 30% by weight, based on the total weight of the N-containing component and the humic substance. In another embodiment, methods of this disclosure provide a coated or non-coated pastille with a N-containing component concentration of 70% to 85% by weight and a humic substance concentration of 30% to 15% by weight, based on the total weight of the N-containing component and the humic substance.

In another embodiment, methods of the disclosure provide coated or non-coated pastilles with a N-containing component concentration of 77.5% to 72.5% by weight and a humic substance concentration of 22.5% to 27.5% by weight, based on the total weight of the N-containing component and the humic substance.

In another embodiment, a method for preparing coated or non-coated N-containing component/humic substance pastille, granule, pellet, prill or extrudate comprises the steps of: a. preparing a pulverized, micronized, powdered or in the form of particulates humic substance. For purposes of the present discussion, a dried humic substance is a humic substance having a moisture content of 3% or less. In an embodiment, the dried humic substance has a moisture content of from 1% to 3% . . . . The humic substance may come from a peat, brown coal, lignite, oxidized lignite (i.e. leonardite), sub bituminous coal, oxidized-sub bituminous coal, bituminous and anthracite coals, sprayed dried humic substances or lignosulfonate; b. mixing the dried humic substance with a granulated/powdered N-containing component, for example, urea that has a low biuret concentration (0-2%) or diammonium phosphate in an appropriate ratio; c. rapidly heating the dry mixture to a molten state and immediately pumping the molten mixture through heated piping to a pelletizer to produce pellets, a granulator to produce granules, an extruder to produce extrudate or pastillation equipment to produce pastilles; and d. heating the pellets/granules/pastilles to 60° to 90° C., coating the pellets with the appropriate amount (10-40%) of the plasticizer dibutyl sebacate, dibutyl phthalate or other appropriate plasticizer and electrostatically coating the pellets, granules, pellets, extrudate or pastilles with micronized ethyl cellulose, or other appropriate polymer for example, cellulose acetate butyrate, cellulose acetate propionate, ethyl cellulose, polyvinyl butyral, polyvinyl chloride, or polystyrene. The coated pellets/granules/extrudate/pastilles are then exposed to a curing process (24 h at 80° C.) to produce slow release, coated N-containing component/humic substance pellets.

In addition, successful electrostatic coating of urea/humic substance fertilizer pastilles using an ethyl cellulose/dibutyl sebacate system was achieved to explore the use of the coating to further extend the time release of urea/humic substance fertilizer.

Embodiments described in the disclosure demonstrated (1) the ability of the fertilizer made by methods of this disclosure to reduce loss of N by suppressing NH₃ volatilization by 20% compared to pure urea, (2) that urea/humic substance fertilizer with 10% to 35% humic substance/humate could be successfully produced using the IPCO ROTOFORM process, a New Mexico humate ore concentration of about 10% to about 35% by weight provides the maximum suppression of NH₃ volatilization while still maintaining sufficient hardness and (3) that the pastilles produced could be coated electrostatically using a coating system comprised of ethyl cellulose (EC) and dibutyl sebacate (DBS).

In the methods of this disclosure, useful N-containing components include urea, monoammonium phosphate and diammonium phosphate. Typically, useful N-containing components of the methods of this disclosure are in the form of pellets, prills particles, powders or mixtures of any of these forms. Mean particle sizes of the N-containing components that may be used in methods of this disclosure are less than 20 mm and range from 2 to 20 mm, 2 to 10 mm or 2 to 6 mm and may be any numerical size in between. Typically, urea used in methods of the disclosure have a low concentration of biuret, for example, from 0 to 2% by weight of urea. N-containing components useful in the methods described in this disclosure typically contain from 0 to less than 5 percent by weight water so to minimize volatilization during melting. In some embodiments, N-containing component may be present in fertilizers in amounts of from 90 to 65, from 85 to 70, from 80 to 70 or from 75 to 70 weight percent based on the total weight of N-containing component and humic substance. The melting temperature of urea is 133° C., ammonium phosphate is 155° C. and diammonium phosphate is 153° C.

Humic substances are materials that contain humic acid, fulvic acid, humin or combinations thereof. In the methods described in this application, the humic substance may be granulated, powdered, spray dried or pulverized/micronized peat, brown coal, lignite, oxidized lignite (leonardite), subbituminous coal, oxidized subbituminous coal, spray dried humate or a lignosulfonate. The humic substance may also be purified humic acid or purified fulvic acid or a combination of humic and fulvic acids. Purified humic and fulvic acids may be derived from oxidized subbituminous coal, brown coal, lignite, oxidized lignite, peat, compost or mixtures thereof. Typically, the particle size of the humic substance useful in the methods of this disclosure range from 0.1 to 35 μm, from 0.5 to 35 μm, from 1 to 25 μm, from 0.1 to 15 μm or from 0.1 to 10 μm and may be less than 1 μm and less than 35 μm, less than 20 μm or less than 10 μm. In the methods of the disclosure, the humic substance includes humic acid or fulvic acid in an amount of at least 40, from 40 to 100, from 40 to 90 or from 40 to 75 weight percent and ash in an amount of from 2 to 30 weight percent or not more than 35 weight percent. In some embodiments, humic substance may be present in fertilizers in amounts of from 10 to 35, from 15 to 30, from 20 to 30, or from 25 to 30 weight percent based on the total weight of the N-containing component and the humic substance.

The pellets/granules/extrudate/pastilles/prills resulting from the methods described in this disclosure typically have a sufficient hardness, that is, have a sufficient crushing strength. Useful crushing strengths for prills are 0.8 to 1.2 kg/prill; 1.5 to 3.5 kg/pellets/granules/extrudates/pastilles as measured by a hand-powered compression tester.

The methods of this disclosure may be a continuous or batch process. In embodiments of this disclosure, the heating of the N-containing component/N-containing component/humic substance mixture may be carried out in a tank or vessel using for example, heat generated by steam, electricity, natural gas and the like. The tanks or vessels used for heating are typically made of metal/metal alloys and may contain various ways to agitate, mix or stir the components with high shear such as impellers or rotors in combination with stators. Typically, when the molten N-containing component/humic substance mixtures are mixed and heated on a commercial scale, the formation of biuret is prevented.

After the N-containing component/humic substance molten mixture is thoroughly mixed, it is pumped or moved to a fluidized bed, a non-fluidized bed, an extruder, or a rotoform pastillator or pastillation process through heated pipes. Once the granules, pellets, extrudate or pastilles are formed, they are actively cooled, for example by a cooled moving belt in the case of a pastillation process, or by heat transfer using ambient or conditioned air in the case of a fluidized or non-fluidized bed.

While combining the urea with humic substance, for example humate ore, does suppress urea volatilization, it might be advantageous to further delay the release of the urea and its conversion to NH₃, NO₂⁻ and NO₃⁻ to prevent losses of N via volatilization and leaching and to deliver it to plants over a more extended time. Various coating systems have been used to produce slow and controlled release (SCR) fertilizers. The hydroscopic nature of both urea and humic substances and the high solubility of urea in aqueous solutions (107.9 g/100 ml) makes difficult or precludes the use of aqueous coatings and the disadvantages of solvent-based coating systems including regulatory restrictions on solvent emissions, waste disposal, and factory vapor levels, makes them undesirable. An alternative that has been exploited by the pharmaceutical industry is electrostatic coating. Compared to aqueous coatings, electrostatic coatings have a shorter processing time and less energy consumption, leading to lower overall costs.

The thickness of this coating system could be varied to produce batches of the N-containing component/humic substance fertilizer for example, pastilles, with ethyl cellulose (EC) coats of different thickness. N-containing component/humic substance fertilizer having different EC coating thicknesses could be mixed to provide coated fertilizers having sustained release over a desired time period.

A plasticizer such as dibutyl sebacate (DBS) may be necessary to reduce the glass transition temperature (Tg) of the EC (130-133° C.), to increase the thermal plasticity of EC and to provide a coating that is more flexible and tougher and resistant to mechanical stress as compared to uncoated pastilles. DBS mixed with EC at concentrations from 20-25% reduce the Tg of EC to about 60° C.

An alternate method of mixing a humic substance with an N-containing component comprises pre-mixing for example, granular, powder, particulate or other small particles of humic substance with for example, granular, powder, particulate or other small particles of N-containing component prior to melting the mixture.

### EXAMPLES

### Materials:

Humate ore, a humic substance, was a pulverized (mean particle size of 6 μm) oxidized, subbituminous coal from the Huma, Inc. mine in New Mexico. The coal had an ash content of about 30% by weight and a humic acid content of 60% by weight.

Urea was obtained from Univar Urea (46%, uncoated).

To assess the effect of humate ore concentration on NH₃ volatilization from the N-containing/humic substance fertilizer disclosed in this disclosure, pastilles were prepared by melting urea in a 20 ml beaker placed in an oil bath that was held at 133° C. (that is, the melting point of urea). Once the urea had melted the appropriate amount of humate ore (see Table 1 below) was added and mixed to produce a homogeneous molten mixture.

The molten mixtures were then poured onto a pre-cooled top piece of a tablet triturate mold that had 4.6×3.2 mm holes drilled into it and that was tightly bolted to another steel plate. Immediately upon contacting the plate and filling the holes, the molten urea/humate ore mixture solidified and hardened. The excess urea/humate ore was scraped off the plate and the pastilles were retrieved by releasing the top plate from the bottom steel plat and pressing the top plate over the base mold which had pins identical in diameter to the top plate holes, to eject the urea fertilizer pastilles.

Urea/humate ore fertilizer pastilles containing 0.5, 1, 2.5, 5, 10 and 20% by weight humate ore were prepared as described above. Comparative Examples 1-5 and Example 1 were prepared using the amounts of urea and humate ore shown below.

TABLE 1

| Sample | Humate ore (g) | Urea (g) |
|---|---|---|
| Comparative Example 1 | 0.05 | 9.95 |
| Comparative Example 2 | 0.1 | 9.9 |
| Comparative Example 3 | 0.25 | 9.75 |
| Comparative Example 4 | 0.5 | 9.5 |
| Comparative Example 5 | 1.0 | 9.0 |
| Example 1 | 2.0 | 8.0 |

Urea/humate ore fertilizer pastilles prepared as describe above, and pure urea pastilles prepared as described above were used to determine (1) if addition of the humate ore could suppress NH₃ volatilization compared to pure urea, (2) if so, to what extent and, (3) what humate ore concentration gave the greatest NH₃ volatilization suppression and hard, freely flowable pastilles.

Ammonia volatilization experiments were conducted as follows: Twenty 250-ml BELLCO biometer flasks modified with rubber stoppered side arms were used to hold 20 ml of a 2% boric acid (BA) solution for trapping volatilized NH₃. The rubber stoppers had a hole through each in which a 30 cm long, blunt tip dispensing needle could be inserted to withdraw and replace the BA solution. During the experiment the hole was covered with tape to prevent the escape of NH₃.

Approximately 30 g (dry weight) of a silty loam soil, sieved to pass a 1-mm sieve, was loaded into each flask. The appropriate amount of deionized water (DI H₂O) was added to the soil in each flask to adjust the moisture content of the soil to 60% of field capacity. The moisture content at field capacity was pre-determined to be 22.7%. The urea/humate ore amounts for each treatment (i.e. 3 flasks per each urea/humate ore fertilizer) were added to achieve a N concentration of 200 lbs of N per acre (224.2 kg N/hectare). The amounts of each component used to prepare each flask for Comparative Examples (CE) 6-11 and Example 2 are shown below in Table 2.

TABLE 2

| | CE 6 | CE 7 | CE 8 | CE 9 | CE 10 | CE 11 | Example 2 |
|---|---|---|---|---|---|---|---|
| Formulation | 0 | 0.5 | 1.0 | 2.5 | 5.0 | 10.0 | 20.0 |
| Humate Ore | | | | | | | |
| wt % | | | | | | | |
| Amount of | 100 | 100 | 100 | 100 | 100 | 100 | 100 |
| Urea for | | | | | | | |
| 200 lbs/acre | | | | | | | |
| N Conc. | | | | | | | |
| (mg) | | | | | | | |
| DI Water | 9 | 9 | 9 | 9 | 9 | 9 | 9 |
| (g/flask) | | | | | | | |

The flasks were then held at 30° C. and 50% relative humidity in a controlled environment incubator. Starting on day 2 and every other day thereafter, the BA was withdrawn from the side-arm of each biometer flask using a 50 ml glass syringe and 30-cm long dispensing needle. The withdrawn BA was transferred to a prelabeled 20 ml glass vials with screwcap and stored refrigerated until analyzed for NH₃ concentration. Immediately after withdrawing and transferring the BA from the sidearm to the vial, the sidearm received 20 ml of fresh BA and the hole in the stopper was resealed with tape.

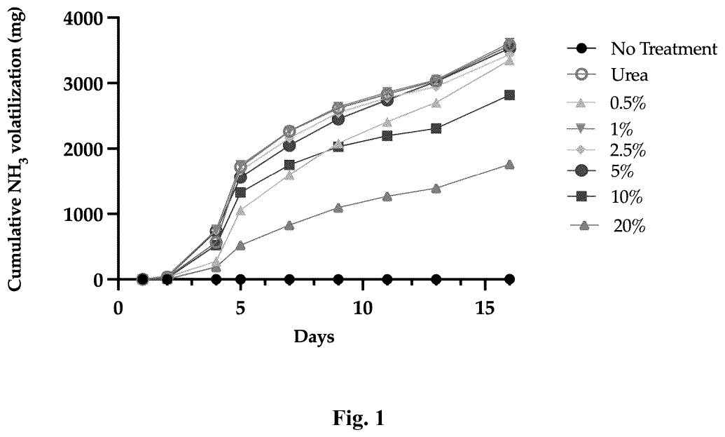

The amount of NH₃ volatilization produced by the above pastille formulations added to soil, as described above, were compared to that of pure urea pastilles over a 16-day period (FIG. 1).

The urea/humate ore fertilizer prepared with 10 and 20% humate ore by weight (CE 11 and Example 2) suppressed NH₃ volatilization significantly less than that amount volatilized from pure urea. After 16 days, the amount of NH₃ volatilized from the pastilles of Example 2 containing 20% humate ore by weight was only 50% (1763 ppm) of the amount of NH₃ volatilized from the pure urea treatment (3576 ppm) as shown in FIG. 1. This was despite initial equivalent urea N concentrations among all treatments.

### Examples 3-5 and CE 12

Pastilles containing 20%, 25% and 30% by weight of humate ore were prepared as described above. The amounts of humate ore and urea for each sample are shown below.

| Sample | Humate ore (g) | Urea (g) |
|---|---|---|
| Example 3 (20% humate ore) | 2.0 | 8.0 |
| Example 4 (25% humate ore) | 2.5 | 7.5 |
| Example 5 (30% humate ore) | 3.0 | 7.0 |
| Comparative Example 12 | 0. | 10 |

Volatilization of NH₃ from pure urea pastilles compared to the urea fertilizer pastilles containing 20%, 25% and 30% weight percent humate ore were compared using the same procedures as described above for Comparative Examples 6-11 and Example 2. The amounts of each component used to prepare each flask for Examples 6-8 and Comparative Example 13 are shown below.

| | Example 6 | Example 7 | Example 8 | CE 13 |
|---|---|---|---|---|
| Formulation | 20 | 25 | 30 | 0 |
| Humate Ore | | | | |
| wt % | | | | |
| Amount of | 100 | 100 | 100 | 100 |
| Urea for | | | | |
| 200 lbs/acre | | | | |
| N Conc. | | | | |
| (mg) | | | | |
| DI Water | 9 | 9 | 9 | 9 |
| (g/flask) | | | | |

The amount of NH₃ volatilization produced by the above pastille formulations added to soil, as described above, were compared to that of pure urea pastilles over a 19-day period. The cumulative % N loss data after 19 days were subjected to linear regression. The regression had an R² value of 0.922 (p<0.00) indicating that all means were significantly different. The results of the cumulative N loss due to NH₃ volatilization demonstrated that a humate ore concentration of 25% by weight gave the greatest suppression of NH₃ and was 20% less compared to pure urea shown in Table 3 below.

TABLE 3
Cumulative loss via NH3 volatilization
from urea and urea/humate ore tablets.

| Treatment | N loss (%) |
|---|---|
| CE 12: Urea, pure | 48.2 |
| Example 3: 20% humate ore | 37.9 |
| Example 4: 25% humate ore | 28.4 |
| Example 5: 30% humate ore | 34.7 |

The urea/humate ore fertilizer pastilles made as described above containing 30% by weight humate ore were very brittle and broke easily. The smaller sizes required to achieve the 200 lbs/acre (224.2 kg/hectare) N application rate of the urea/humate ore fertilizer containing 30% by weight humate ore may explain the reduced ability to suppress NH₃ volatilization, compared to the 25% by weight humate ore in the urea/humate ore fertilizer shown in Table 4 below.

In the samples immediately above (results shown in Table 3) humidity was not maintained at 50%, but was higher. As a result, the soils became very wet and this may have reduced the effectiveness of the urea/humate ore fertilizer to suppress NH₃ volatilization compared to what was observed in Comparative Examples 6-11 and Example 2.

Pastilles were made using a ROTOFORM 4G pastillation system (available from, IPCO). The pastilles made on the ROTOFORM 4G pastillation system contained 20%, 20% and 25% by weight humate ore. The moisture content of the pulverized humate ore was measured at about 20% prior to pastillation. To prevent evaporative cooling of the molten urea from H2O evaporation, the humate ore was dried overnight in an oven at 110° C. to a final moisture content of 3.2% prior to use. The pastillation conditions, amounts of urea and humate ore used and amounts of C, N, humic acid and biuret for Examples 6-8 are shown below in Table 4.

TABLE 4

| | Humate | Pastillation | Urea | Humate | Carbon | Nitrogen | Humic Acid | Biuret |
|---|---|---|---|---|---|---|---|---|
| Example | Ore (%) | Conditions | (kg) | Ore (kg) | (wt. %) | (wt. %) | (wt. %) | (wt. %) |
| 6 | 20 | Urea melted | 20 | 5 | 30.16 | 38.19 | 12.97 | 7.06 |
| | | first and | | | | | | |
| | | humate ore | | | | | | |
| | | was added | | | | | | |
| | | to molten | | | | | | |
| | | urea for 1 | | | | | | |
| | | hour | | | | | | |
| 7 | 20 | Urea and | 16 | 4 | 25.58 | 37.33 | 12.2 | 7.61 |
| | | humate ore | | | | | | |
| | | were mixed | | | | | | |
| | | together in a | | | | | | |
| | | solid state | | | | | | |
| | | and melted | | | | | | |
| | | together | | | | | | |
| 8 | 25 | Urea melted | 25 | 8.33 | 27.11 | 36.31 | 14.8 | 4.9 |
| | | first for 4 | | | | | | |
| | | hours. Then | | | | | | |
| | | humate ore | | | | | | |
| | | was added | | | | | | |
| | | over a 10 | | | | | | |
| | | min period | | | | | | |
| | | and then | | | | | | |
| | | mixed for | | | | | | |
| | | 10 min. | | | | | | |

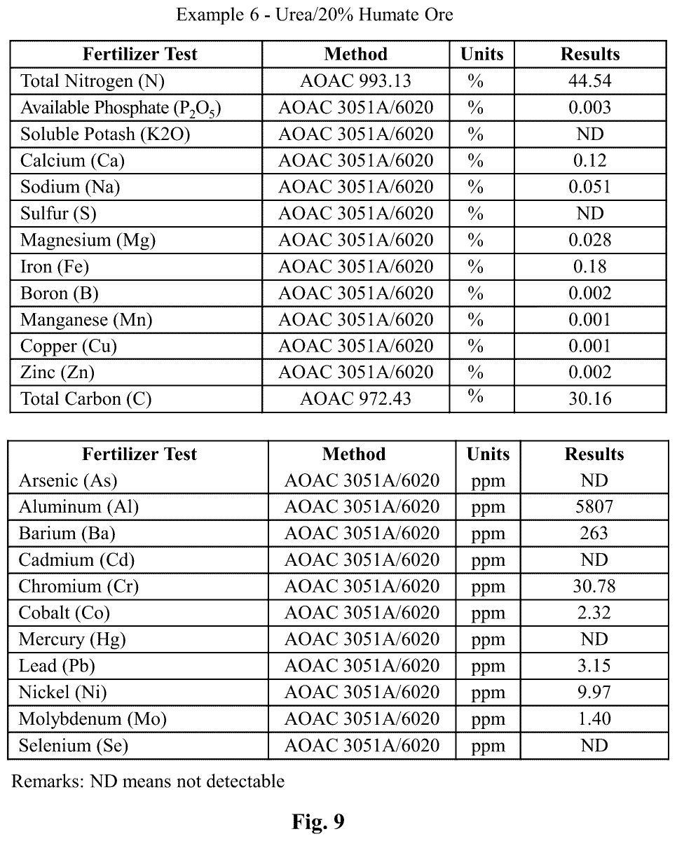

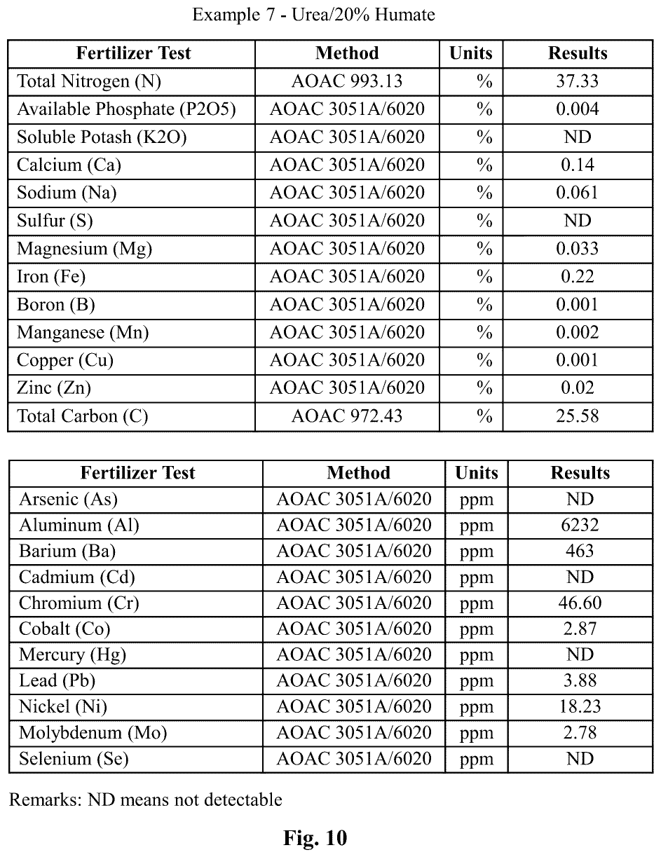

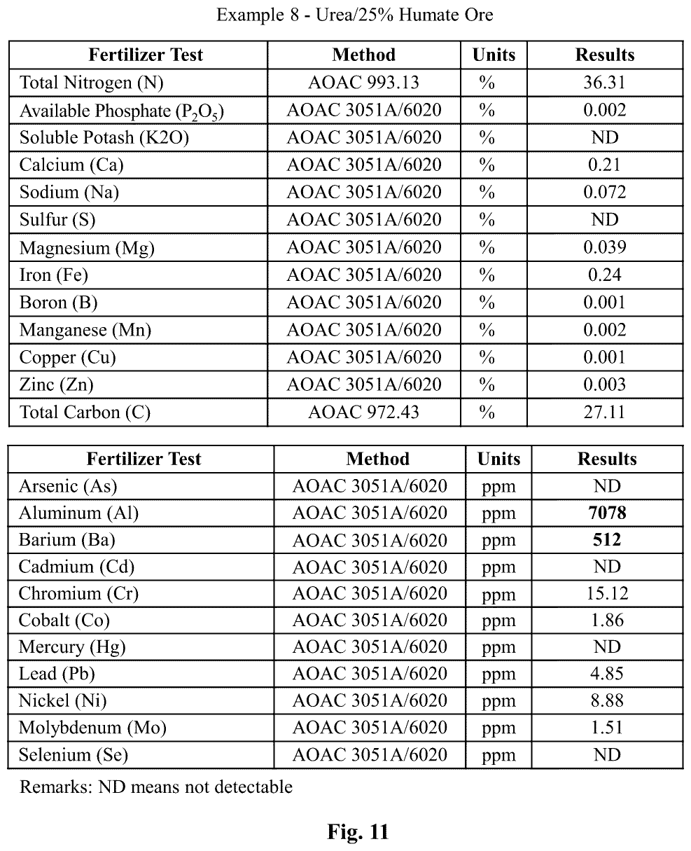

Samples of Examples 6-8 were analyzed for chemical composition (BHN). Results are shown in FIGS. 9-11.

All three Example formulations were successfully made. During mixing of Example 7 in the molten state, some foaming of the molten urea/humate ore mixture was observed which clogged the edges of the ROTOFORM 4G pastillation system.

The biuret concentration of the urea/humate ore fertilizer samples ranged from 4.9-7.6%. In all three Examples 6-8, the urea was melted in a 60 L container for 4 hours. Therefore, the formation of biuret was likely due to the long holding time of the urea at temperatures above its melting point (i.e. 133° C.) which is well known to result in the evolution of NH₃ and formation of biuret and other urea transformation products.

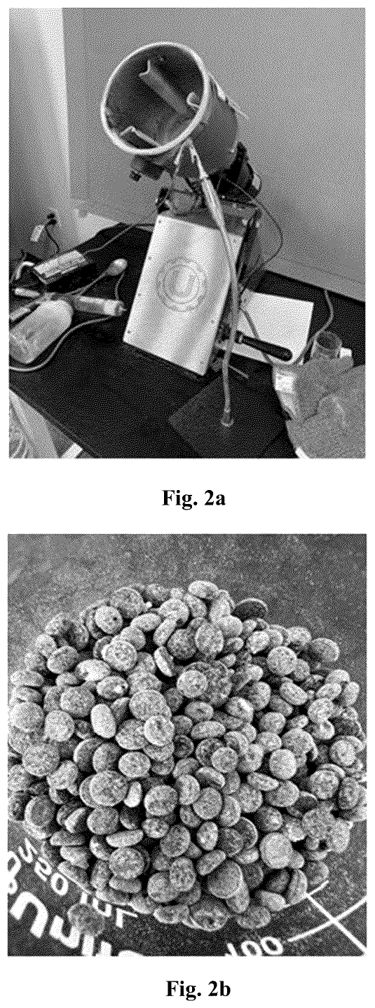

Coating of the Pastilles: Electrostatic coating of the urea/humate ore fertilizer pastilles produced from the ROTOFORM 4G system in Examples 6-8 (described above) was evaluated. The coating system used was a two-part system comprised of the naturally occurring polymer ethyl cellulose (EC) (5% by weight) along with a plasticizer, dibutyl sebacate (DBS) (0.5 percent by weight). The electrostatic coating system is shown in FIG. 2a.

FIG. 2a shows the system for electrostatic coating of pastilles. The system consisted of a rotating drum seed coater, fitted with a silicon heating blanket, copper ground and EASTWOOD HOTCOAT PCS-250 dual voltage powder coating system. FIG. 2b shows the urea/humate ore fertilizer pastilles containing 25% by weight humate ore coated with the EC/DBS coating system.

Example 9: Two-hundred-fifty grams (250 g) of the urea/humate ore fertilizer pastilles (Examples 6-8) was loaded into the rotating drum seed coater, adjusting the temperature control of the heating blanket to a setting that heated the pastilles to 60° C. and starting the drum rotation. An aqueous solution of DBS was prepared by dissolving 5 g of DBS in 100 ml of DI water and EC powder (4 cP, 48% ethoxyl SIGMA 200646) was loaded into the electrostatic gun powder reservoir. Once the urea/humate ore pastilles reached a temperature of 60° C., the DBS solution was sprayed onto the pastilles followed immediately by electrostatic coating with the EC. This alternate process was repeated several times to get complete coverage of the pastilles (FIG. 2b).

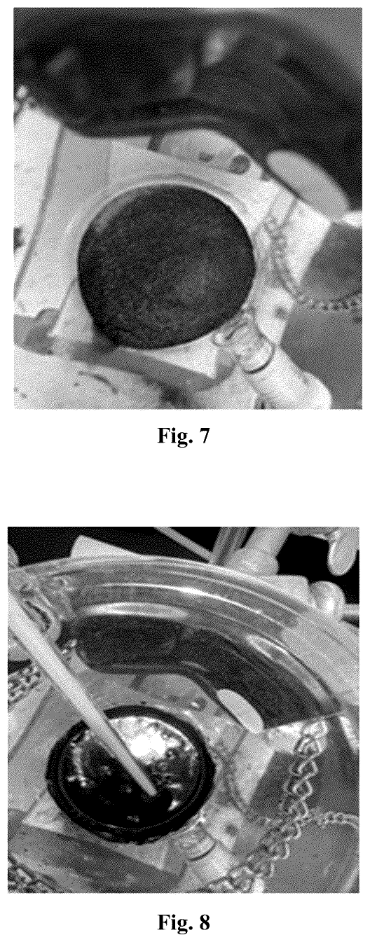

In an experiment, 15 g granulated urea and 5 g micronized humate ore were thoroughly mixed together prior to melting. The resulting mixture is shown in FIG. 6. The premixed urea/humate ore was then loaded into the jacketed beaker (FIG. 7). The temperature was adjusted to about 138° C. to melt the mixture. Once the mixture was melted, the temperature was re-adjusted to 133° C. When the pre-mixed mixture melted it retained a smooth flowable texture as shown in FIG. 8.

The result of the above lab-scale experiment shows that a pastillation/extrusion/fluidized bed/nonfluidized bed process without an in-line mixer can be made to work using this approach. For example, micronized humate ore/humic substance can be premixed with granulated urea at the desired ratio (for example, 25:75 by weight). The pre-mixed urea/humate ore/humic substance can then be fed into a rapid melter and be pumped right to the ROTOFORM pastillator. The rapid melter should be located as close to the ROTOFORM pastillator as possible. Also, the feeding rate of the urea/humate ore/humic substance mix to the rapid melter should be synchronized to the rate of feeding the molten mixture to the ROTOFORM pastillator.

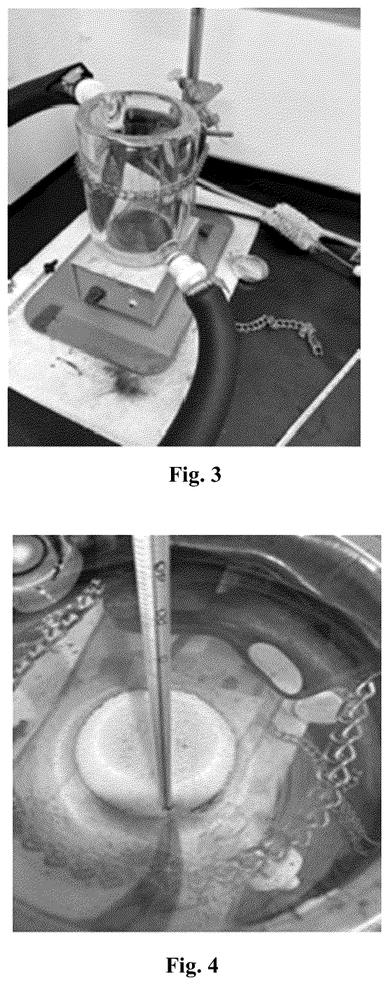

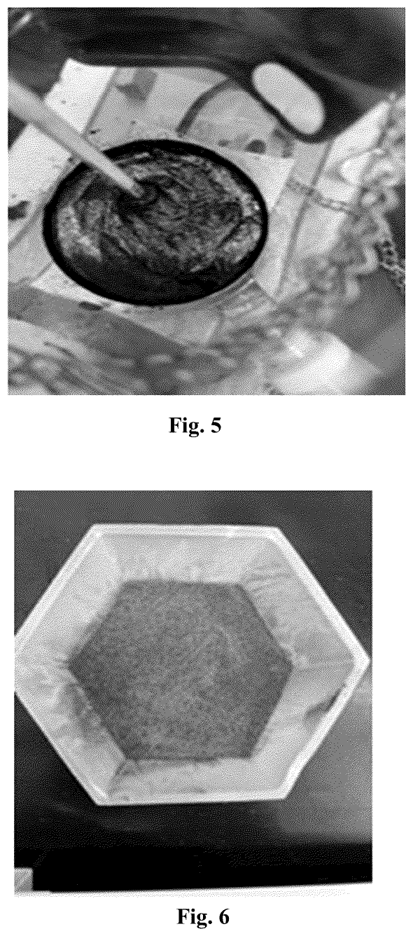

FIG. 3 shows a lab-scale heater/chiller used to heat a 600 ml jacketed beaker to the relevant temperature range. As described above, urea was melted in the jacketed beaker (FIG. 4) and then humate ore was added with stirring. In this sample, the mixture does start to foam (FIG. 5) and is too light to be able to be pumped.

The foregoing description is just an explanation of the present invention, rather than a limitation of the present invention, and any innovation and creation that do not exceed in the connotation scope of the present invention all fall within protection scope of the present invention. Thus, the scope of the invention should be determined by the appended claims and their legal equivalents, rather than by the examples given.

What is claimed is:

1. A method comprising the steps of:
heating a solid nitrogen-containing component;
adding a particulate humic substance having a mean particle size of less than 35 μm to the molten nitrogen-containing component in the amount of 10 to 35 weight percent based on the total weight of the nitrogen-containing component and the humic substance;
mixing the molten nitrogen containing component and the humic substance under high shear to form a substantially uniform molten fertilizer mixture;
forming fertilizer granules of the molten fertilizer mixture; and
actively cooling the fertilizer granules.

2. The method according to claim 1 wherein the humic substance comprises 40-100 weight percent humic acid.

3. The method according to claim 1 wherein the humic substance comprises 40-100 weight percent fulvic acid.

4. The method according to claim 1 wherein the nitrogen containing component is monoammonium phosphate, diammonium phosphate or urea.

5. The method according to claim 1 wherein the humic substance is selected from the group consisting of oxidized subbituminous coal, brown coal, lignite, oxidized lignite, peat, compost or mixtures thereof.

6. The method according to claim 1 wherein the humic substance comprises purified humic acid.

7. The method according to claim 1 wherein the method further comprises the step of applying at least one coating to the granules.

8. The method according to claim 1 wherein the humic substance is added to the heated nitrogen-containing component in the amount of 15 to 30 weight percent based on the total weight of the nitrogen-containing component and the humic substance.

9. The method according to claim 1 wherein the nitrogen-containing component is urea and the humic substance is subbituminous coal.

10. The method according to claim 1 wherein the forming and cooling of the fertilizer granules is by a pastillation process or an extrusion process.

11. A fertilizer comprising:
granules comprising 10 to 35 percent by weight of a humic substance and 65 to 85 percent by weight of a nitrogen-containing component, the or granules made by heating a solid nitrogen-containing component;
adding a particulate humic substance having a mean particle size of less than 35 μm to the heated nitrogen-containing component in the amount of 10 to 35 weight percent based on the total weight of the nitrogen-containing component and the humic substance;
mixing the heated nitrogen containing component and the humic substance under high shear to form a substantially uniform fertilizer mixture;
forming granules from the fertilizer mixture; and
actively cooling the granules.

12. A method comprising the steps of:
mixing 10 to 35 weight percent nitrogen-containing component with 65 to 90 weight percent of a humic substance having a mean particle size of less than 35 μm to form a mixture;
heating the mixture to form a liquid mixture;
forming granules from the molten mixture; and
actively cooling the granules.

13. The method according to claim 12 wherein the humic substance comprises 40 to 100 weight percent humic acid.

14. The method according to claim 12 wherein the humic substance comprises 40 to 100 weight percent fulvic acid.

15. The method according to claim 12 wherein the nitrogen-containing component is monoammonium phosphate, diammonium phosphate or urea.

16. The method according to claim 12 wherein the humic substance is oxidized subbituminous coal, brown coal, lignite, oxidized lignite, peat, compost or mixtures thereof.

17. The method according to claim 12 wherein the method further comprises the step of applying at least one coating to the granules.

18. The method according to claim 12 wherein 15 to 30 weight percent humic substance is mixed with the 70 to 85 weight percent nitrogen-containing component based on the total weight of the nitrogen-containing component and the humic substance.

19. The method according to claim 12 wherein the nitrogen-containing component is urea and the humic substance is subbituminous coal.

20. A fertilizer made by the process of claim 12.
